(19) United States
(12) Patent Application Publication
(10) Pub. No.: US 2013/0013195 A1
(43) Pub. Date: Jan. 10, 2013

(54) Optimum Route Generation Based on Common Purchase Plan of Different Travelers

(75) Inventors: Barry A. Kritt, Raleigh, NC (US); Sarbajit K. Rakshit, Kolkata (IN); Shawn K. Sremaniak, Raleigh, NC (US)

(73) Assignee: INTERNATIONAL BUSINESS MACHINES CORPORATION, Armonk, NY (US)

(21) Appl. No.: 13/178,478

(22) Filed: Jul. 7, 2011

(51) Int. Cl. G01C 21/00

(52) U.S. Cl. 701/439

(57) ABSTRACT

A computer system and computer program product are provided to manage travel for purchasing items. A computer system identifies items for purchase by a group of people. The computer system identifies a set of requirements for the items. The computer system retrieves information about available items at locations for purchasing the items. The computer system can then generate a set of routes for the group of people that includes at least a portion of the locations for purchasing the items based on the set of requirements for the items, and the information about the available items at the locations for purchasing the items.

### BACKGROUND

1. Field

The disclosure relates generally to a computer implemented method, computer system, and computer program product. More specifically, the disclosure relates to a computer implemented method, computer system, and computer program product for managing travel for purchasing items.

2. Description of the Related Art

Computerized travel routing systems assist motorists in determining preferred routes in traveling between two or more locations. Users typically specify a starting point and an ending destination, and the travel routing system determines the route with the shortest distance between the two locations. Alternatively, the travel routing system may determine the route with the shortest travel time between the two locations. Various web sites are currently available that provide this functionality to online users. In addition, certain car manufacturers have incorporated similar computerized mapping systems into their automobiles' on-board computer systems.

In general, computerized travel routing systems function as follows. After a user enters starting and ending destinations, the travel routing system accesses a map database containing road information. Each road in the database may be broken up into segments. The segments may begin and end at intersections, speed zones, or a change in the number of lanes. The information of a road segment in the map database may include: the length of the segment, speed limit, and which road segments connect to the endpoints of the segment. The travel routing system may plot out a number of probable routes comprised of road segments connecting the starting point and the destination. An estimated travel time for each route may be calculated by summing the quotient of the distance traveled in a particular speed zone by the speed limit of the zone. A travel route may then be selected based on the shortest travel distance, shortest estimated time required to travel the route, or some combination of the two. The selected travel route may then be displayed to the user.

Although conventional computerized travel routing systems, as described above, unique problems arise when planning a route for a group of travelers. Each of the travelers may have locations, services, or goods that they would like to visit or acquire. Determining an optimal route between the various locations or merchants that each traveler desires to visit becomes more complicated. Additionally, consolidating the various locations or merchants for the routing system can be cumbersome.

### SUMMARY

According to one embodiment of the present invention, a computer implemented method, computer system, and computer program product are provided for managing travel for purchasing items. A computer system identifies items for purchase by a group of people. The computer system identifies a set of requirements for the items. The computer system retrieves information about available items at locations for purchasing the items. The computer system can then generate a set of routes for the group of people that includes at least a portion of the locations for purchasing the items based on the set of requirements for the items and the information about the available items at the locations for purchasing the items.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is an illustration of a data processing system in accordance with an illustrative embodiment;

FIG. 3 is a diagram of a client in the form of a mobile telephone in accordance with an illustrative embodiment;

FIG. 4 is a block diagram of a mobile telephone in accordance with an illustrative embodiment;

FIG. 5 is a block diagram of a system for managing travel for purchasing items in accordance with an illustrative embodiment;

FIG. 6 is a screenshot of a mobile telephone executing route generation software in accordance with an illustrative embodiment;

FIG. 7 is a screenshot of a mobile telephone executing route generation software in accordance with an illustrative embodiment; and

FIG. 8 is a flowchart for managing travel for purchasing items in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

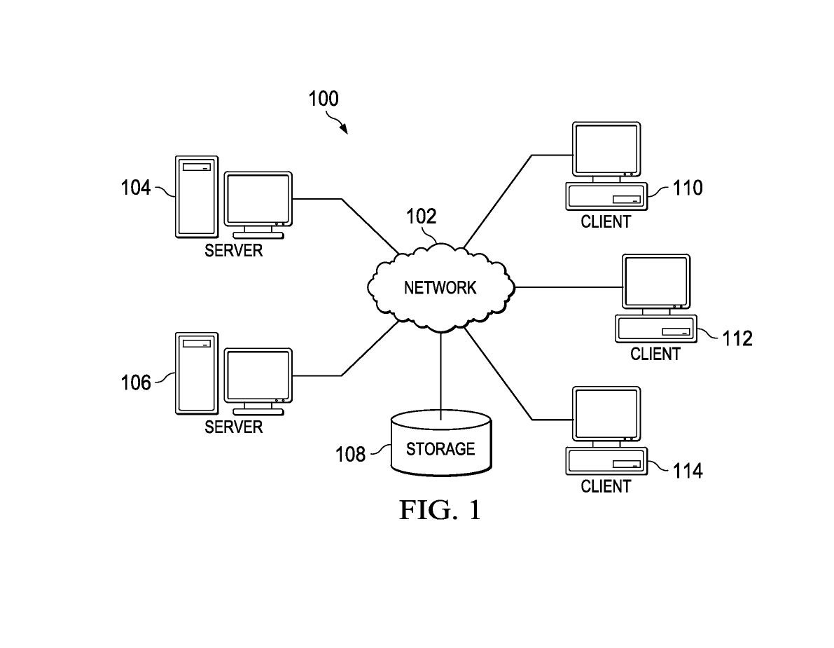

With reference now to the figures, and in particular with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

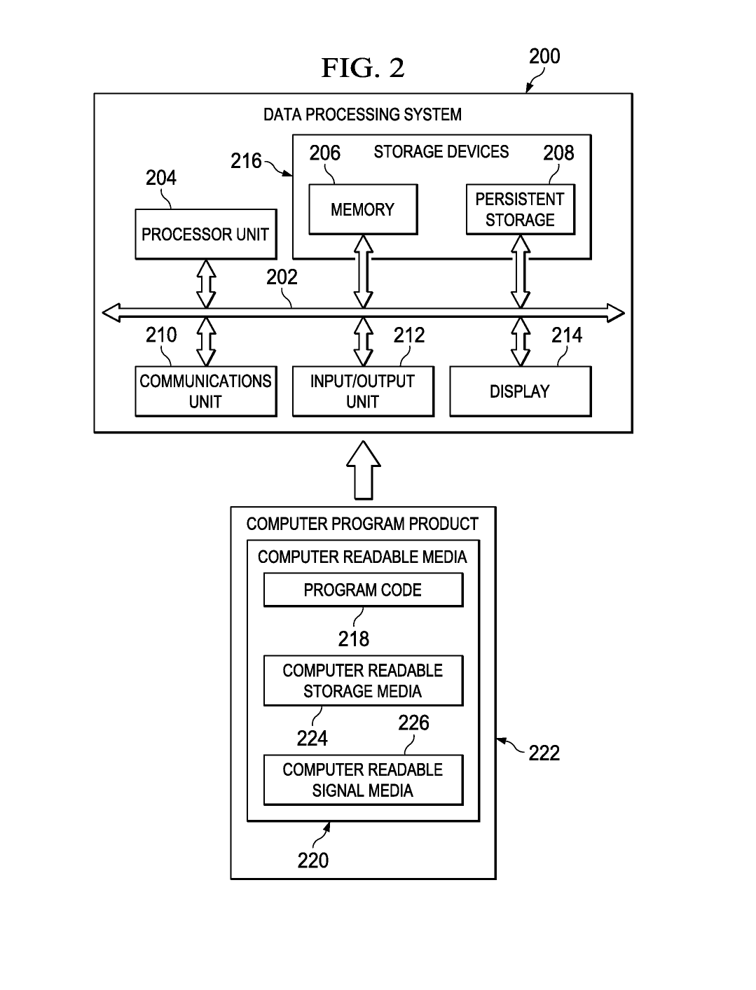

Turning now to FIG. 2, an illustration of a data processing system is depicted in accordance with an illustrative embodiment. In this illustrative example, data processing system 200 includes communications framework 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. in these examples, communications unit 210 is a network interface card. Communications unit 210 may provide communications through the use of either or both physical and wireless communication links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications framework 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded. onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these examples, computer readable storage media 224 is a physical or tangible storage device used to store program code 218 rather than a medium that propagates or transmits program code 218. Computer readable storage media 224 is also referred to as a computer readable tangible storage device or a computer readable physical storage device. In other words, computer readable storage media 224 is a media that can be touched by a person.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communication links, such as wireless communication links, optical fiber cable, coaxial cable, a wire, and/or any other suitable type of communications link. In other words, the communications link and/or the connection may be physical or wireless in the illustrative examples.

In some advantageous embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different advantageous embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated. with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications framework 202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 206, or a cache, such as found in an interface and memory controller hub that may be present in communications framework 202.

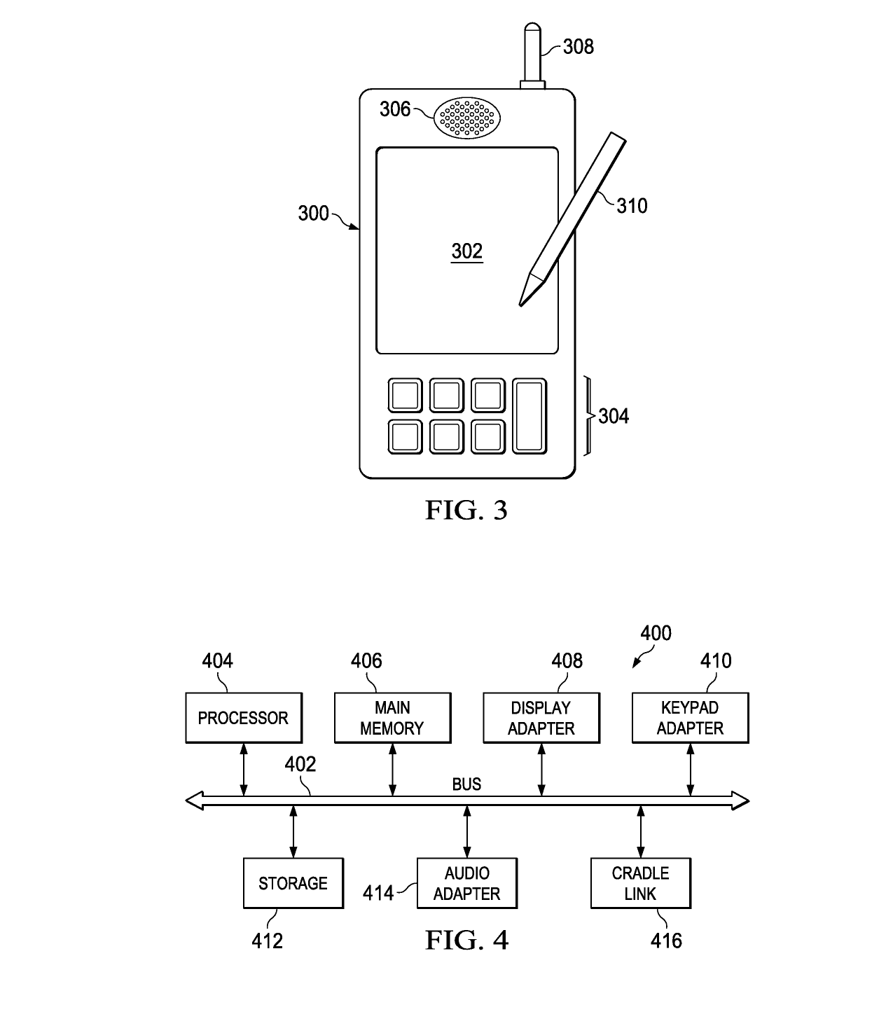

With reference now to FIG. 3, a diagram of a client in the form of a mobile telephone is depicted in accordance with an illustrative embodiment. Mobile telephone 300 includes display 302 for presenting textual and graphical information. Display 302 may be a known display device, such as a liquid crystal display (LCD) device. The display may be used to present a map or directions, calendar information, a telephone directory, or an electronic mail message. in these examples, display 302 may receive user input using an input device such as, for example, stylus 310. Alternatively, display 302 can be a touch screen display that receives user input a user directly touching display 302.

Mobile telephone 300 may also include keypad 304, speaker 306, and antenna 308. Keypad 304 may be used to receive user input in addition to using display 302. Speaker 306 provides a mechanism for audio output, such as presentation of an audio file. Antenna 308 provides a mechanism used in establishing a wireless communications link between mobile telephone 300 and a network, such as network 102 in FIG. 1.

Mobile telephone 300 also preferably includes a graphical user interface that may be implemented by means of systems software residing in computer readable media in operation within mobile telephone 300.

Turning now to FIG. 4, a block diagram of a mobile telephone is depicted in accordance with an illustrative embodiment. Mobile telephone 400 is an example of a mobile telephone, such as mobile telephone 300 in FIG. 3, in which code or instructions implementing the processes of the present invention may be located. Mobile telephone 400 includes a bus 402 to which processor 404 and main memory 406 are connected. Display adapter 408, keypad adapter 410, storage 412, and audio adapter 414 also are connected to bus 402. Cradle link 416 provides a mechanism to connect mobile telephone 400 to a cradle used in synchronizing data in mobile telephone 400 with another data processing system. Further, display adapter 408 also includes a mechanism to receive user input from a stylus when a touch screen display is employed.

An operating system runs on processor 404 and is used to coordinate and provide control of various components within mobile telephone 400. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to, or in place of, the hardware depicted in FIG. 4.

The illustrative embodiments described herein provide a method for managing travel for purchasing items. A computer system identifies items for purchase by a group of people. The computer system identifies a set of requirements for the items. The computer system retrieves information about available items at locations for purchasing the items. The computer system can then generate a set of routes for the group of people that includes at least a portion of the locations for purchasing the items based on the set of requirements for the items and the information about the available items at the locations for purchasing the items.

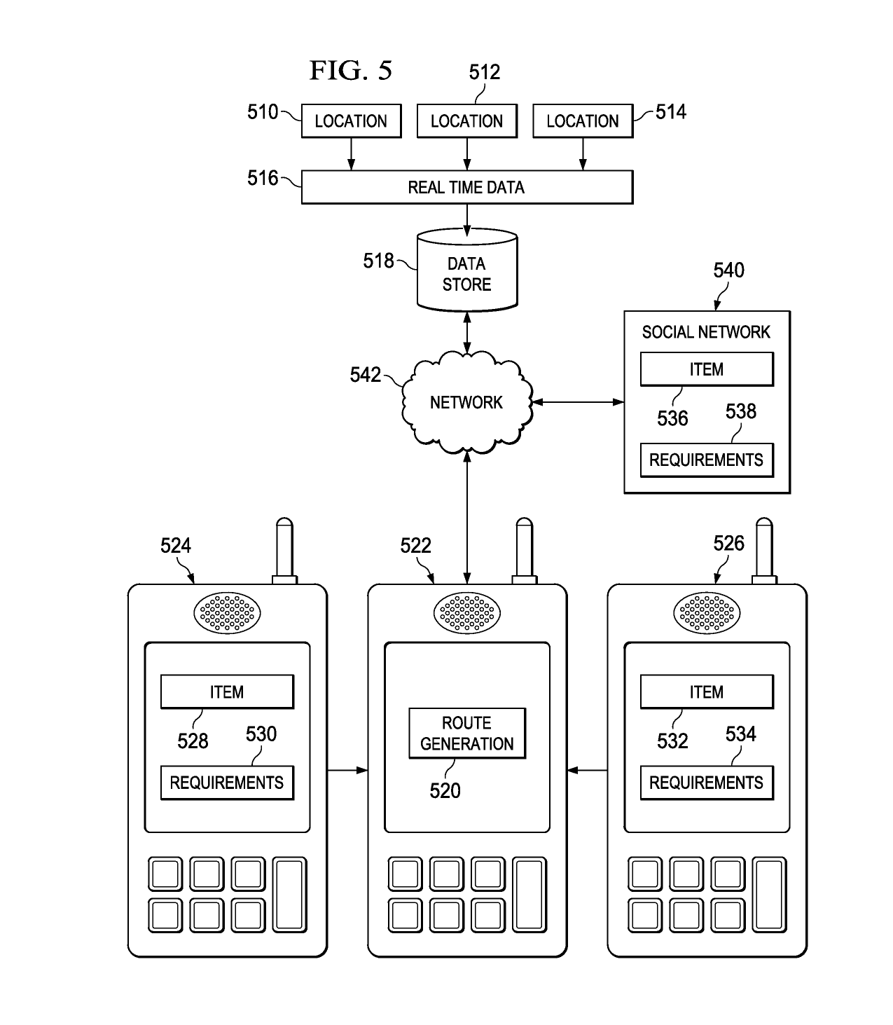

Referring now to FIG. 5, a block diagram of a system for managing travel for purchasing items is depicted in accordance with an illustrative embodiment.

Location 510, location 512, and location 514 are brick and mortar establishments providing goods and services for purchase by consumers. Location 510, location 512, and location 514 can be retail stores or wholesale stores. Additionally, location 510, location 512, and location 514 can be facilities providing services to a consumer that are provided at location 510, location 512, and location 514. The services can include, for example, but not limited to, personal grooming or pampering and professional services, such as legal or medical services.

Each of location 510, location 512, and location 514 provides real time data 516 to data store 518. Real time data 516 is an inventory or menu of the product inventory and available services that are currently stocked or provided by each of location 510, location 512, and location 514. Real time data 516 can include, but is not limited to, identification information of the goods and services being offered, availability information of the goods and services being offered, and price ranges of the goods and services being offered.

Identification information. of the goods and services being offered can be a unique identifier of the goods and services being offered. Such a unique identifier can be, for example, a part number, model number, or catalogue number of a specific good or service. Identification information of the goods and services being offered can be a vague identifier of the goods and services being offered. Such a vague identifier can be, for example, but not limited to, a physical description of the good or service, a particular brand of the good or service, and characteristics of the good or service. For example, a vague identifier for a particular good could identify a television having a 42 inch screen size having a 120 hertz refresh rate manufactured by a particular company.

Real time data 516 can be consolidated in data store 518. Data store 518 is a server, such as one of server computer 104 and server computer 106 of FIG. 1. Data store 518 provides a data structure to store real time data 16 provided by each of location 510, location 512, and location 514.

In one illustrative embodiment, location 510, location 512, and location 514 are provided access to data store 518 through a subscription service. Each of location 510, location 512, and location 514 can subscribe to a service provided by data store 518. When one of location 510, location 512, and location 514 subscribe to the service, then goods and services provided by the subscribing one of each of location 510, location 512, and location 514 are discoverable by a requesting route generation software, such as route generation 520.

Route generation 520 is a software application executing on mobile telephone 522. Based on real time data 516 retrieved from data store 518, a current location of the user, as well as identified items and their requirements, route generation 520 determines a physical navigation route between various ones of location 510, location 512, and location 514 that are able to provide the requested goods and services.

Mobile telephone 522 is mobile telephone 300 of FIG. 3. Mobile telephone 522 runs route generation 520. Route generation 520 is capable of receiving real time information for goods and services provided by various ones of location 510, location 512, and location 514 from data store 518. Route generation 520 is further capable of receiving items for purchase, as well as requirements for those items from other mobile telephones, such as mobile telephone 524 and mobile telephone 526. Route generation 520 is further capable of receiving items for purchase, as well as requirements for those items from social network 540. Route generation 520 is further capable of receiving items for purchase, as well as requirements for those items from mobile telephone 522.

Mobile telephone 524 and mobile telephone 526 are mobile telephones, such as mobile telephone 300 of FIG. 3. Each of mobile telephone 524 and mobile telephone 526 is capable of receiving items for purchase, as well as requirements for those items through a user input, such as display 302 of FIG. 3. In one illustrative embodiment, mobile telephone 524 can receive item 528 and requirements 530 and mobile telephone 526 can receive item 532 and requirements 534 in a software application. In one illustrative embodiment, the software application can be similar or identical to route generation 520.

Route generation 520 can also receive items for purchase, as well as requirements for those items, such as item 536 and requirements 538 from social network 540. Social network 540 is an online service, platform, or site that focuses on building and reflecting relationships among users of the service. Mobile telephone 522 can connect to social network 540 across network 542.

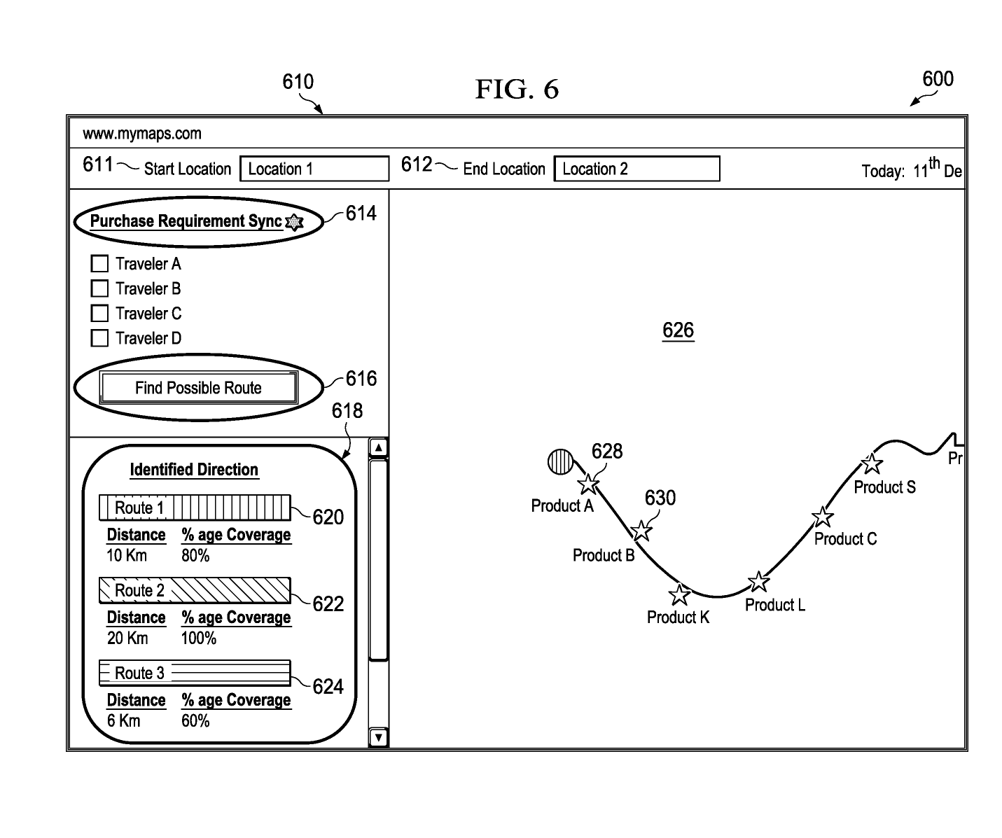

Referring now to FIG. 6, a screenshot of a mobile telephone executing route generation software is depicted in accordance with an illustrative embodiment. Mobile telephone 600 can be mobile telephone 300 of FIG. 3, Screenshot 610 can be a screenshot of route generation 520 of FIG. 5.

Start location 611 is an input for a geographical location at which a route, determined by route generation software, should begin. Start location 611 can be a street address or intersection, global positioning coordinates, a name of a building or landmark, or other location identifier. End location 612 is an input for a geographical location at which a route, determined by route generation software, should end. End location 612 can be a street address or intersection, global positioning coordinates, a name of a building or landmark, or other location identifier.

Synchronization button 614 is a button that instructs route generation software to retrieve items and requirements, such as items 528, 532, and 536 of FIG. 5. When synchronization button 614 is selected, route generation software will scan for other mobile devices in the area. Route generation software can then identify any mobile devices found through a handshake authentication. Once the other mobile devices have been identified, items and requirements therefore can be retrieved from the identified mobile devices.

Additionally, when synchronization button 614 is selected, route generation software can connect to a social network, such as social network 540 of FIG. 5, Route generation software can then retrieve any items and requirements therefore from the social network.

Find route button 616 is a button that instructs route generation software to generate one or more routes based on the retrieved items and requirements therefore. The routes generated begin at start location 611 and end at end location 612. The routes generated traverse at least one location, such as at least one of location 510, location 512, and location 514 of FIG. 5.

Once possible routes are generated, possible routes are displayed in route window 618. Possible routes 620, 622, and 624 are listed by a route distance and a coverage percentage. The route distance is a distance traversed by the route when traveling from start location 611 to end location 612. Because locations, such as location 510, location 512, and location 514 of FIG. 5 may not lie on a most direct path between start location 611 and end location 612, routes identified can vary in their distance. Coverage percentage is an indication of a percentage of items, as restricted by their requirements, that can be purchased at locations traversed by the route. For example, a coverage percentage of 80% indicates that 80% of the identified items can be purchased at locations along the corresponding route.

Map window 626 is a graphical indication of an identified route, including locations along the route as well as the various items that can be purchased at those locations. For example, along the route shown in map window 626, a purchase of at least one item according to that item's requirements can be made at location 628. A purchase of at least one subsequent item according to that item's requirements can be made at location 630.

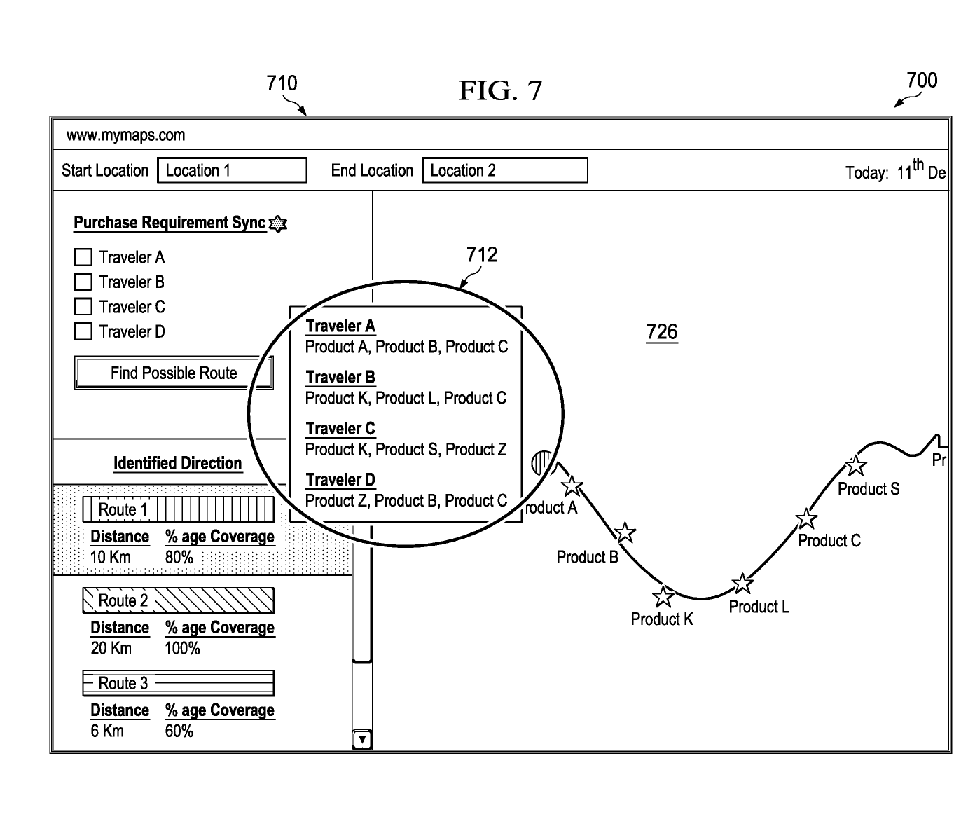

Referring now to FIG. 7, a screenshot of a mobile telephone executing route generation software is depicted in accordance with an illustrative embodiment. Mobile telephone 700 can be mobile telephone 300 of FIG. 3. Screenshot 710 can be a screenshot of route generation 520 of FIG. 5.

Screenshot 710 shows route details window 712. When a particular route is selected, route details window 712 shows a detailed indication of which items that are requested for each user can be purchased along the selected route. For example, with the current route selection indicated in screenshot 710, traveler A is able to purchase item A, item B, and item C. Traveler B is able to purchase item K, item L, and item C. Locations that have the items in stock for sale according to the item requirements are illustrated along the selected route as shown in map window 726. Map window 726 is map window 626 of FIG. 6. Upon selection of any route, route details window 712 allows a user to view which products are available for purchase for each traveler on the selected route. A user can then decide whether a different route should be selected based on percent coverage and route distance for the different route.

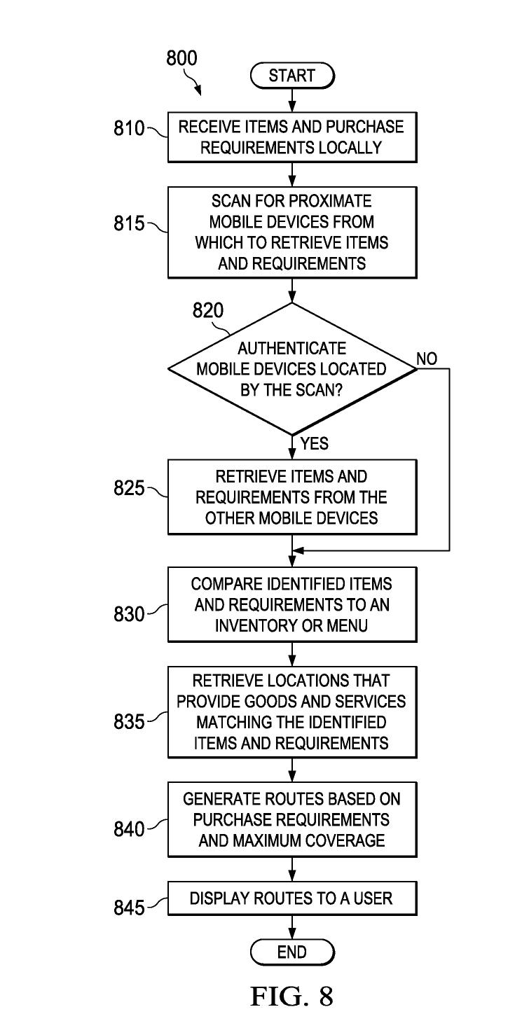

Referring now to FIG. 8, a flowchart for managing travel for purchasing items is depicted in accordance with an illustrative embodiment. Process 800 is a software process executing on a software component, such as route generation 522 of FIG. 5.

Process 800 begins by locally receiving items and purchase requirements (step 810). The items can be a list of items sought to be purchased by a user of a mobile device, such as mobile telephone 522 of FIG. 5.

Process 800 can then scan for proximate mobile devices from which to retrieve items and requirements (step 815). The other mobile devices can be, for example, mobile telephone 524 and mobile telephone 526 of FIG. 5. Process 800 then attempts to authenticate any mobile devices located by the scan (step 820). Process 800 can authenticate located devices, for example, through a handshake authentication. Responsive to not authenticating any mobile devices located by the scan (“no” at step 820), process 800 proceeds directly to step 830. Responsive to authenticating any mobile devices located by the scan (“yes” at step 820), process 800 retrieves items and requirements from the other mobile devices (step 825). In one illustrative embodiment, a synchronization button within route generation software is selected. When the synchronization button is selected, the route generation software wilt scan for other mobile devices in the area. The route generation software can then identify any found mobile devices through a handshake authentication. Once the other mobile devices have been identified, items and requirements therefore can be retrieved from the identified mobile devices. In one illustrative embodiment, process 800 can retrieve items and requirements by establishing a personal area network with the authenticated devices. The personal area network can be, for example a Bluetooth® connection to the authenticated device.

Process 800 then compares the identified items and requirements to an inventory or menu of the product inventory and available services that are currently stocked or provided by brick and mortar establishments providing goods and services for purchase by consumers (step 830). In one illustrative embodiment, process 800 connects to a server tracking inventory or menu of the product inventory and available services that are currently stocked or provided by subscribing locations, such as one of location 510, location 512, and location 514 of FIG. 5. The server can be, for example, data store 518 of FIG. 5. Each location can be a retail store or a wholesale store. Additionally, each location can be a facility providing services to a consumer, such as, for example, hut not limited to, personal grooming or pampering and professional services, such as legal or medical services. Process 800 then can retrieve locations that provide goods and services matching the identified items and requirements (step 835). In one illustrative embodiment, real time updates of inventory, prices, and available services can be updated in real time from the server. Thus, as inventory changes at a given location, those changes can be sent to route generation software for real time adjustments to the generated route.

Responsive to retrieving locations that provide goods and services matching the identified items and requirements, process 800 generates routes based on purchase requirements and maximum coverage (step 840). The generated routes seek to maximize the items that can be purchased at locations along the route while minimizing the route distance between the starting location, such as start location 611 of FIG. 6 and the ending location, such as end location 612 of FIG. 6.

In one illustrative embodiment, process 800 can give preference to those items that are common items and locations among more than one user. Thus, the route generation software may preferentially generate a route that accesses locations at which common items are located and those locations at which multiple identified items can be purchased. Similarly, process 800 can discriminate against those locations at which only one of the identified items can be purchased. Discriminating against a location may include generating a route that avoids the discriminated location or presenting a route that includes the discriminated location, but presenting the route later in a listing of possible routes.

Responsive to generating the routes, process 800 displays the routes to a user (step 845) with the process terminating thereafter. The routes can be displayed, for example, as possible routes within a route window, such as route window 618 of FIG. 6. Users can then select one of the proposed routes based on the route distance and the coverage percentage of the route.

Thus, illustrative embodiments of the present invention provide a computer implemented method, computer system, and computer program product for managing travel for purchasing items. A computer system identities items for purchase by a group of people. The computer system identifies a set of requirements for the items. The computer system retrieves information about available items at locations for purchasing the items. The computer system can then generate a set of routes for the group of people that includes at least a portion of the locations for purchasing the items based on the set of requirements for the items and the information about the available items at the locations for purchasing the items.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement, over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-11. (canceled)

12. A computer storage medium having a computer program product encoded thereon for managing travel for purchasing items, the computer program product comprising:
computer usable instructions for identifying the items for purchase by a group of people;
computer usable instructions for identifying a set of requirements for the items;
computer usable instructions for retrieving information about available items at subscribing locations for purchasing the items, wherein the available items at the subscribing locations are discoverable if the subscribing location is subscribed to a subscription service that provides information about an inventory or menu of product inventory and available services that are currently stocked or provided by the subscribing locations; and
computer usable instructions for generating a set of routes for the group of people that includes at least a portion of the subscribing locations for purchasing the items based on the set of requirements for the items and the information about the available items at the subscribing locations for purchasing the items.

13. The computer storage medium of claim 12, wherein the computer usable instructions for generating the set of routes comprises:
computer usable instructions for generating the set of routes for the group of people that includes at least the portion of the subscribing locations for purchasing the items based on the set of requirements for the items, the information about the available items at the subscribing locations for purchasing items, and a set of locations that a portion of the group of people desire to see.

14. The computer storage medium of claim 12, wherein the set of requirements comprises a first requirement from a first traveler of the group of people and a second requirement from a second traveler of the group of people.

15. The computer storage medium of claim 12, wherein the set of requirements include requirements to purchase one or more products or services or a combination of product and services.

16. The computer storage medium of claim 14, wherein the set of requirements include identification information, availability information, and price ranges of products and services.

17. The computer storage medium of claim 12, wherein the computer usable instructions for identifying the set of requirements comprises:
computer usable instructions for retrieving the set of requirements from a set of mobile computing devices by the group of people.

18. The computer storage medium of claim 12, wherein the computer usable instructions for identifying the set of requirements comprises:
computer usable instructions for retrieving the set of requirements from a social network.

19. The computer storage medium of claim 12 further comprising:
computer usable instructions for selecting a route in the set of routes that most closely meets the set of requirements.

20. The computer storage medium of claim 19, wherein the computer usable instructions for selecting the route in the set of routes that most closely meets the set of requirements is further based on a rule for satisfying requirements of the group of people.

21. The computer storage medium of claim 20, wherein the rule for satisfying the requirements of the group of people is a rule for selecting the requirements common to the group of people or a rule for coverage of the set of requirements.

22. The computer storage medium of claim 21 further comprising:
computer usable instructions for displaying a list of two or more routes in the set of routes that most closely meets the set of requirements for selection by the group of people.

23. A mobile computing device comprising:
a memory having computer usable program code for managing travel for purchasing items encoded thereon;
a bus connecting the memory to a processor; and
a processor, wherein the processor executes the computer usable program code to identify the items for purchase by a group of people; to identify a set of requirements for the items;
to retrieve information about available items at subscribing locations for purchasing the items, wherein the available items at the subscribing locations are discoverable if the subscribing location is subscribed to a subscription service that provides information about an inventory or menu of product inventory and available services that are currently stocked or provided by the subscribing locations; and to generate a set of routes for the group of people that includes at least a portion of the subscribing locations for purchasing the items based on the set of requirements for the items and the information about the available items at the subscribing locations for purchasing the items.

24. The mobile computing device of claim 23, wherein the processor executing the computer usable program code to generate the set of routes comprises the processor executing the computer usable program code:
to generate the set of routes for the group of people that includes at least the portion of the subscribing locations for purchasing the items based on the set of requirements for the items, the information about the available items at the subscribing locations for purchasing the items, and a set of subscribing locations that a portion of the group of people desire to see.

25. The mobile computing device of claim 23, wherein the set of requirements comprises a first requirement from a first traveler of the group of people and a second requirement from a second traveler of the group of people.
